(19) United States
(12) Patent Application Publication
(10) Pub. No.: US 2010/0000576 A1
(43) Pub. Date: Jan. 7, 2010

(54) Method of Cleaning Beer Preheaters In An Ethanol Plant

(75) Inventors: D. Christopher Romer, Memphis, TN (US); Richard Hopkins, Marionville, MO (US)

Correspondence Address: AIR LIQUIDE;Intellectual Property, 2700 POST OAK BOULEVARD, SUITE 1800, HOUSTON, TX, 77056, US

(73) Assignee: Lurgi PSI, Inc., Memphis, TN (US)

(21) Appl. No.: 12/494,448

(22) Filed: Jun. 30, 2009

Related U.S. Application Data
(60) Provisional application No. 61/077,999, filed on Jul. 3, 2008.

(51) Int. Cl. B08B 9/00; B08B 3/08

(52) U.S. Cl. 134/22.11; 134/22.17

(57) ABSTRACT

A method for cleaning exchangers including providing a heat exchanger with a liquid contact side and a vapor contact side, providing acid to clean the liquid contact side, and providing caustic to clean the vapor contact side is provided. In the method, the exchanger may be a beer preheater. In the method, the acid may be sulfamic acid. In the method, the liquid contact side may be the beer side. In the method, the exchanger may be a plate-in-frame heat exchanger or a a shell-and-tube heat exchanger. In the method, the acid may be provided from a central storage tank. In the method, there may be a recirculation pump. In the method, the acid may be provided from a local storage tank.

This application claims the benefit of U.S. Provisional Application No. 61/077,999, filed Jul. 3, 2008, the entire contents of which are incorporated herein by reference.

### BACKGROUND

A variety of cereal grains and other plants are grown for use as food. Major cereal grains include corn, rice, wheat, barley, sorghum (milo), millets, oats, and rye. Other plants include potatoes, cassava, and artichokes. Corn is the most important cereal grain grown in the United States. A mature corn plant consists of a stalk with an ear of corn encased within a husk. The ear of corn consists of about 800 kernels on a cylindrical cob. The kernels are eaten whole and are also processed into a wide variety of food and industrial products. The other parts of the corn plant (i.e., the stalk, leaves, husk, and cob) are commonly used for animal feed, but are sometimes processed into a variety of food and industrial products.

In more detail, the corn kernel consist of three main parts: (1) the pericarp; (2) the endosperm; and (3) the germ. The pericarp (also known as the seed coat or bran) is the outer covering of the kernel. It consists primarily of relatively coarse fiber. The endosperm is the energy reserve for the plant. It consists primarily of starch, protein (also known as gluten), and small amounts of relatively fine fiber. The germ (also known as the embryo) consists primarily of oil and a miniature plant with a root-like portion and several embryonic leaves.

Starch is stored in a corn kernel in the form of discrete crystalline bodies known as granules. Starch is a member of the general class of carbohydrates known as polysaccharides. Polysaccharides contain multiple saccharide units (in contrast to disaccharides which contain two saccharide units and monosaccharides which contain a single saccharide unit). The length of a saccharide chain (the number of saccharide units in it) is sometimes described by stating its “degree of polymerization” (abbreviated to D.P.). Starch has a D.P. of 1000 or more. Glucose (also known as dextrose) is a monosaccharide (its D.P. is 1). Saccharides having a D.P. of about 5 or less are sometimes referred to as sugars.

As mentioned above, the pericarp and endosperm of the corn kernel contain fiber. The fiber comprises cellulose, hemicellulose, lignin, pectin, and relatively small amounts of other materials. Fiber is present in relatively small amounts in the corn kernel, but is present in much greater amounts in other corn components such as the cob, husk, leaves, and stalk. Fiber is also present in other plants. The combination of cellulose and lignin is sometimes known as lignocellulose and the combination of cellulose, lignin, and hemicellulose is sometimes known as lignocellulosic biomass. As used herein, the term “fiber” (and its alternative spelling “fibre”) refers to cellulose, hemicellulose, lignin, and pectin.

A wide variety of processes have been used to separate the various components of corn. These separation processes are commonly known as corn refining. One of the processes is known as the dry milling process. In this process, the corn kernels are first cleaned and then soaked in water to increase their moisture content. The softened corn kernels are then ground in coarse mills to break the kernel into three basic types of pieces—pericarp, germ, and endosperm. The pieces are then screened to separate the relatively small pericarp and germ from the relatively large endosperm. The pericarp and the germ are then separated from each other. The germs are then dried and the oil is removed. The remaining germ is typically used for animal feed. The endosperm (containing most of the starch and protein from the kernel) is further processed in various ways. As described below, one of the ways is to convert the starch to glucose and then ferment the glucose to ethanol.

Fermentation is a process by which microorganisms such as yeast digest sugars to produce ethanol and carbon dioxide. Yeast reproduce aerobically (oxygen is required) but can conduct fermentation anaerobically (without oxygen). The fermented mixture (commonly known as the beer mash) is then distilled to recover the ethanol. Distillation is a process in which a liquid mixture is heated to vaporize the components having the highest vapor pressures (lowest boiling points). The vapors are then condensed to produce a liquid that is enriched in the more volatile compounds.

With the ever-increasing depletion of economically recoverable petroleum reserves, the production of ethanol from vegetative sources as a partial or complete replacement for conventional fossil-based liquid fuels becomes more attractive. In some areas, the economic and technical feasibility of using a 90% unleaded gasoline-10% anhydrous ethanol blend (“gasohol”) has shown encouraging results. According to a recent study, gasohol powered automobiles have averaged a 5% reduction in fuel compared to unleaded gasoline powered vehicles and have emitted one-third less carbon monoxide than the latter. In addition to offering promise as a practical and efficient fuel, biomass-derived ethanol in large quantities and at a competitive price has the potential in some areas for replacing certain petroleum-based chemical feedstocks. Thus, for example, ethanol can be catalytically dehydrated to ethylene, one of the most important of all chemical raw materials both in terms of quantity and versatility.

### SUMMARY

The present invention is a method for cleaning exchangers including providing a heat exchanger with a liquid contact side and a vapor contact side, providing acid to clean the liquid contact side, and providing caustic to clean the vapor contact side. In the present invention the exchanger may be a beer preheater. In the present invention the acid may be sulfamic acid. In the present invention, the liquid contact side may be the beer side. In the present invention the exchanger may be a plate-in-frame heat exchanger or a a shell-and-tube heat exchanger. In the present invention, the acid may be provided from a central storage tank. In the present invention, there may be a recirculation pump. In the present invention, the acid may be provided from a local storage tank.

### DESCRIPTION OF PREFERRED EMBODIMENTS

Both caustic and sulfamic acid cleaning are presently known in the art for cleaning beer/mash exchangers and mash coolers in ethanol plants. A typical design known to the skilled artisan, for cleaning beer preheaters includes caustic cleaning on the beer side, but usually has no provisions for sulfamic acid cleaning or for any cleaning of the vapor side. It has been determined that during process upsets, sulfamic acid cleaning may be beneficial on the beer side of the exchanger and that caustic cleaning may be beneficial, from time to time, on vapor side due to solids carryover. Under some conditions, continuous sulfamic acid cleaning of the beer preheater may also be necessary during normal operations. The ability to caustic clean the vapor side was found to useful on more than one occasion.

The design for preheater cleaning is not the same for all projects. In some instances, the preheater clean-in-place (CIP) supply and return lines may be the same size as the CIP headers to evaporator area. In one embodiment of the present invention, the sulfamic acid is stored in a large tank that is central to the facility, and relatively large supply and return lines are required to provide the acid to the heat exchanger.

In another embodiment of the present invention, a recirculation pump is provided, to introduce an adequate (maximum) flow rate (velocity) during cleaning and smaller supply and return lines. If a design has recirculation pumps; smaller lines can be run for supply and return to reduce cost.

In another embodiment of the present invention, a Nalgene (Polyethylene) tank is installed, to store sulfamic acid locally, and this embodiment may have recirculation at the preheaters and only run one small line for both supply and return.

The decision of which alternative should be implemented would ordinarily be based on cost. If the distance from the sulfamic acid tank to the beer preheaters is great, it may be less costly to install a recirculation pump, a small supply/return line, and Nalgene tank than to run larger supply and return headers.

In some embodiments, the capability to sulfamic acid clean beer, including, but not limited to, both plate exchangers and shell and tube exchangers is required.

In some embodiments, the capability to caustic clean shell and tube beer preheaters is required.

In some embodiments, the capability to caustic clean the flash side of plate beer preheaters is required.

In some embodiments, the make-up water for the sulfamic acid solution, may preferably be evaporator condensate at 135 deg. F. In other embodiments, the make-up water for the sufamic acid solution may be process condensate at 100 deg. F. Process (plant) water should not be used.

What is claimed is:

1. A method for cleaning exchangers comprising:
providing a heat exchanger with a liquid contact side and a vapor contact side,
providing acid to clean the liquid contact side, and
providing caustic to clean the vapor contact side.

2. The method of claim 1, wherein said exchanger is selected from the group consisting of beer preheater.

3. The method of claim 1, wherein said acid further comprises sulfamic acid.

4. The method of claim 2, wherein said liquid contact side comprises the beer side.

5. The method of claim 1, wherein said exchanger is a plate-in-frame heat exchanger.

6. The method of claim 1, wherein said exchanger is a shell-and-tube heat exchanger.

7. The method of claim 1, wherein said acid is provided from a central storage tank.

8. The method of claim 7, further comprising a recirculation pump.

9. The method of claim 1, wherein said acid is provided from a local storage tank.

10. The method of claim 9, further comprising a recirculation pump.
